(19) United States
(12) Patent Application Publication
(10) Pub. No.: US 2009/0267752 A1
(43) Pub. Date: Oct. 29, 2009

(54) Vehicle instrument panel

(75) Inventor: Choong Seob Park, Gyeonggi-do (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/220,930

(22) Filed: Jul. 30, 2008

(30) Foreign Application Priority Data
Apr. 29, 2008 (KR) 10-2008-0039880

(51) Int. Cl. B60Q 1/00

(52) U.S. Cl. 340/461

(57) ABSTRACT

The present invention relates to a vehicle instrument panel. As described above, the vehicle instrument panel includes a text panel indicating a graduation and a character; a pointer having a multi-fraction shape, while an end portion moves over the surface of the text panel; and a display unit which is formed in the same height as the text panel and indicates an information of vehicles. The present invention has the effect that the convenience of user is increased by minimizing the blind area of the vehicle instrument panel.

### CROSS-REFERENCE TO RELATED APPLICATION

This application claims under 35 U.S.C. §119(a) the benefit of Korean Patent Application No. 10-2008-39880 filed Apr. 29, 2008, the entire contents of which are incorporated herein by reference.

### BACKGROUND OF THE INVENTION

The present invention relates to a vehicle instrument panel, more particularly, to a vehicle instrument panel which is capable of improving the visibility by arranging the LCD part of the center substantially identically with the height of a graduated text panel to minimize the blind region.

Generally, the vehicle instrument panel, which may be referred to as a cluster gauge, is an instrument panel which informs a driver of the overall driving status of vehicle. While looking forward, the driver frequently looks at the vehicle instrument panel and assesses the driving status.

Vehicle instrument panels of the related art can include a tachometer, a speed-meter, a coolant thermometer, and a fuel indicator, and indicate information including the engine rotation speed of the vehicle which is sensed through a detection sensor, the driving speed, the coolant temperature and the fuel state information by the movement of a needle. Thus, the driver is able to determine the velocity of the vehicle that the driver operates by reading the number that is indicated by a corresponding needle. Accordingly, the driver controls the driving status while driving the vehicle with reference to this information.

As shown in exemplary FIG. 1, the vehicle instrument panel of the related art implements a text panel 12 of a fan shape having a given angle, or in other cases of a circular shape, and a certain number is indicated in every graduation, while a pointer 14 preferably rotates around a LCD (liquid crystal display) part 16 of the central part to indicate a value, including the RPM (revolution per minute), the speed, the coolant temperature, and the fuel content.

In a conventional vehicle instrument panel, the LCD part 16 is arranged to be higher than the text panel 12 so that the pointer 14 floats on the text panel 12 surface to rotate.

According to this arrangement, the LCD part 16 is higher than the text panel 12, and the LCD part 16 is more protruded in front of a driver in comparison with the text panel 12. Accordingly, a blind area may be generated at the side viewing angle.

### SUMMARY OF THE INVENTION

In one aspect, the present invention is directed to a vehicle instrument panel which is able to minimize the blind area by manufacturing the height of an LCD part and a text panel to be identical, or substantially identical.

In order to achieve the above-mentioned object, according to a preferred embodiment of the invention, provided is a vehicle instrument panel preferably including, but not limited to, a text panel indicating a graduation and a character; a pointer having a multi-fraction shape, while an end portion moves over the surface of the text panel; and a display unit which is preferably formed in the same height as the text panel and indicates an information of vehicles.

Preferably, the display unit includes a LCD (liquid crystal display) unit. The vehicle instrument panel according to an aspect of the invention further includes a LED (Light Emit Diode) which delivers a light to the pointer. In other preferred embodiments, the vehicle instrument panel further includes a LED (Light Emit Diode) which delivers a light to the display unit. The vehicle instrument panel can further include a prism which diffuses a light irradiated from the LED. Preferably, the pointer has a form which is suitably bended at least three times or more. The vehicle instrument panel according to an embodiment of the invention further includes a flexible cable which delivers a power and a control signal to the display unit.

According to another preferred embodiment of the invention, provided is a vehicle instrument panel including a prism which is bended with a given angle; a LCD (liquid crystal display) which is suitably formed in the upper portion of the prism and indicates an information of vehicles; a text panel which is separated with a given distance to both sides of the LCD, while being suitably formed with the same height as the LCD; and a pointer which is bended like the prism, while having a form which is suitably bended at least one or more times in order that one side is exposed at the upper portion of the text panel.

The vehicle instrument panel according to another embodiment of the invention further includes a diffusion panel and a reflector which diffuses and reflects a light respectively between the prism and the LCD.

The vehicle instrument panel according to another embodiment of the invention further includes a plurality of LEDs (Light Emit Diode) which deliver a light to the pointer and the LCD.

The vehicle instrument panel according to another embodiment of the invention further includes a step motor which rotates the pointer.

The vehicle instrument panel according to another embodiment of the invention further includes a flexible cable which delivers a power and a control signal to the LCD.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a drawing showing the front side of a vehicle instrument panel of the related art.

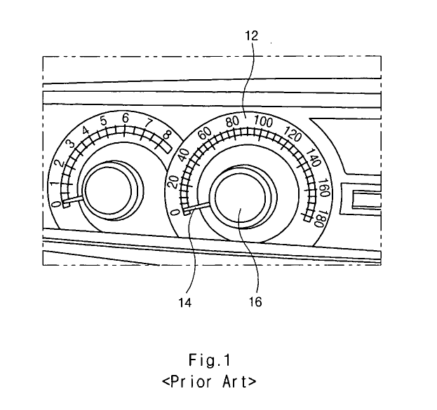

FIG. 2 is a drawing showing the front side of a vehicle instrument panel according to the present invention.

FIG. 3 is a cross-sectional view of a vehicle instrument panel according to the present invention.

FIG. 4a is a sectional picture showing a part configuration of the vehicle instrument panel of FIG. 3.

FIG. 4b is a separated perspective view of the vehicle instrument panel of FIG. 3.

<Reference Numerals>

| | |
|---|---|
| 100: speedmeter | 200: tachometer |
| 300: fuel indicator | |
| 116: diffusing panel and reflector | |
| 12, 130: text panel | 14, 120: pointer |
| 16, 118, 210: LCD (liquid crystal display) | |
| 102: PCB substrate | 104: step motor |
| 106: connector | |
| 108a, 108b: LED(light emit diode) | |
| 112, 204: prism | 114: flexible cable |
| 122: case | 202: lower case |
| 206: reflector | 208: diffusing panel |
| 212: upper case | |

### DESCRIPTION OF SPECIFIC EMBODIMENTS

As described herein, the present invention includes a vehicle instrument panel comprising a text panel indicating a graduation and a character a pointer having a multi-bending shape, while an end portion moves over the surface of the text panel, and a display unit. In one embodiment, the display unit is the same height, or substantially the same height (e.g. within 6, 5, 4, 3, 2, or 1% of the same height, as the text panel and indicates vehicle information. In a further embodiment, the display unit includes a LCD (liquid crystal display) unit. The invention also includes a motor vehicle that comprises a vehicle instrument panel as described herein.

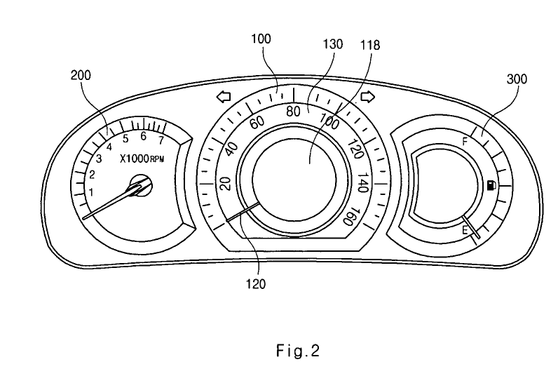

Hereinafter, the vehicle instrument panel of the present invention will be described in detail with reference to exemplary FIGS. 2 to 4b.

FIG. 2 is a drawing showing the front side of an exemplary vehicle instrument panel of the present invention.

In one embodiment, the vehicle instrument panel of the present invention includes a vehicle instrument panel a speedmeter 100, a tachometer 200, and a fuel indicator 300.

Preferably, the speedmeter 100 is positioned in the central part of the vehicle instrument panel to indicate the velocity of vehicle with a pointer 120. According to preferred embodiments, the height of a LCD liquid crystal display part 118 of the central part of the speedmeter 100 and a text panel 130 are identical, or substantially identical. In further preferred embodiments, the pointer 120 has a a multi-bending form, and only one side of the pointer 120 is exposed at the upper portion of the text panel 130. Accordingly, the LCD part 118 can be made to- be suitably larger because the exposed pointer 120 length is short.

In other exemplary embodiments, the tachometer 200 is equipped on the left side of the speedmeter 100 to indicate the number of rotations of the engine, that is, the RPM (revolutions per minute). Preferably, the fuel indicator 300 indicates the status of the fuel content with pointer.

According to other preferred embodiments, the tachometer 200 and the fuel indicator 300 also can be suitably made so that the height of the text panel 130 and the LCD part 118 of the center are identical or substantially identical to the speedmeter 100 and, preferably, a multi-bending pointer is used. Accordingly, the LCD part 118 can be made substantially larger.

In exemplary FIG. 2, the coolant thermometer indicating the coolant temperature of vehicle is not shown. In preferred embodiments, vehicle instrument panel of the present invention may further include a coolant thermometer. The coolant thermometer also can be designed by making the height of the text panel and the LCD part of the center identical and using, preferably, a multi-bending pointer.

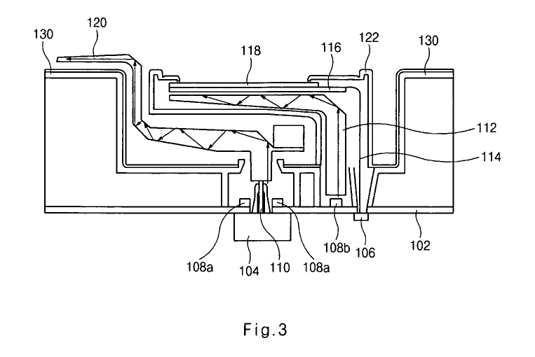

Hereinafter, the structure of the vehicle instrument panel and the pointer, preferably a multi-bending pointer, will be described in detail with reference to the cross-sectional view of exemplary FIG. 3.

In preferred embodiments, the vehicle instrument panel of the invention includes, but is not limited to include, a suitable PCB substrate 102, a step motor 104 formed at the lower portion of the PCB substrate 102, a LED 108a which is suitably formed at the upper portion of the PCB substrate 102 to irradiate a light to the pointer 120, a LED 108b which is suitably formed at the upper portion of the PCB substrate 102 to irradiate a light to a prism 112, a pointer central axis 110 which is suitably formed at the upper portion of the motor 104 to be connected to the pointer 120, a pointer 120 which has a multi-bending form while being connected to the upper portion of the pointer central axis 110, a prism 112 which delivers the light of the LED 108b to the diffusing panel and the reflector 116, which suitably has a given angle and is thus in a bending form, the diffusing panel and the reflector 116, which suitably diffuse and reflect a light while being formed in a given thickness on the upper portion of the prism 112, a flexible cable 114 which supplies a control signal and a power to a LCD part 118, a connector 106 which is connected to the flexible cable 114, the LCD part 118 which is suitably formed in the upper portion of the diffusing panel and the reflector 116 to indicate the information of vehicles (such as the vehicle speed information), a case 122 which surrounds from the prism 112 to the LCD part 118, a text panel 130 which is formed with the same height as the LCD part 118 while being separated from the case 122 in a predetermined distance (pointer 120 movable space).

In further embodiments, the step motor 104 is implemented with the motor having a high torque characteristic. The LCD part 118 may preferably be in a circular form, however other polygonal shapes are within the scope of the invention.

In additional preferred embodiments, the case 122 is formed with [symbol] shaped feature like the prism 112.

In other preferred embodiments, the pointer 120 comprises light-emitted by the light irradiated from the LED 108a. In certain examples, the pointer is formed between the case 122 and the text panel 130 with the multi bending form which is bended at least three times or more, and a part of the end portion of the pointer 120 is exposed at the upper portion of the text panel 130 to move over the surface of the text panel 130.

In related embodiments, as only the end part of the pointer 120 is exposed to the text panel 130 surface, the length of the exposed pointer 120 becomes shorter, so that the size of the LCD part 118 can be increased as much as the shortened length of the exposed pointer 120. Further, as the size of the LCD part 118 is increased, while being formed with the same height as the text panel 130, the blind region is accordingly reduced.

In further embodiments, as shown in FIG. 3, the light emitted from the LED 108a, 108b is reflected through the pointer 120 and the prism 112 to thus irradiate.

Accordingly, the present invention can reduce the non-visible region due to the protruded LCD part 118 by forming the LCD part 118 of the central part, suitably including the speedmeter, the fuel indicator, and tachometer, identically or substantially identically, with the height of the text panel 130. To suitably achieve this, the present invention uses a bended pointer 120 which is preferably bended at least, but not limited to, three times or more.

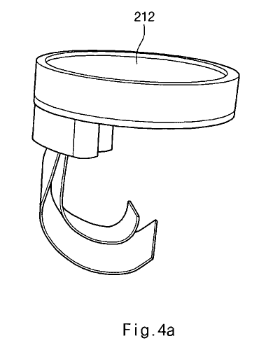

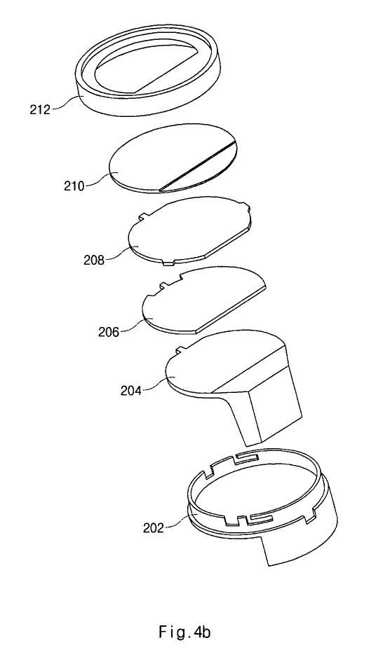

Exemplary FIG. 4a is a sectional picture showing a preferred partial configuration of the vehicle instrument panel of FIG. 3. FIG. 4b is a separated perspective view of the vehicle instrument panel of FIG. 3.

As shown in exemplary FIG. 4b, the vehicle instrument panel of FIG. 3 is formed by sequentially laminating a lower case 202 in which the upper end is preferably circular and the side is a preferably [symbol] shaped feature, a prism 204 in which the side is a preferably [symbol] shaped feature, a reflector 206, a diffusing panel 208, a LCD 210 and a circular upper case 212.

As described above, the present invention is effective in increasing the convenience of a user by minimizing the blind area of a vehicle instrument panel.

What is claimed is:

1. A vehicle instrument panel comprising:
a text panel indicating a graduation and a character;
a pointer having a multi-bending shape, while an end portion moves over the surface of the text panel; and
a display unit which is formed in the same height as the text panel and indicates an information of vehicles.

2. The vehicle instrument panel of claim 1, wherein the display unit includes a LCD (liquid crystal display) unit.

3. The vehicle instrument panel of claim 1, further comprising a LED (Light Emit Diode) which delivers a light to the pointer.

4. The vehicle instrument panel of claim 1, further comprising a LED (Light Emit Diode) which delivers a light to the display unit.

5. The vehicle instrument panel of claim 4, further comprising a prism which diffuses a light irradiated from the LED.

6. The vehicle instrument panel of claim 1, wherein the pointer has a form which is bended at least three times or more.

7. The vehicle instrument panel of claim 1, further comprising a flexible cable which delivers a power and a control signal to the display unit.

8. A vehicle instrument panel comprising:
a prism which is bended with a given angle;
a LCD (liquid crystal display) which is formed in the upper portion of the prism and indicates an information of vehicles;
a text panel which is separated with a given distance to both sides of the LCD, while being formed with the same height as the LCD; and
a pointer which is bended like the prism, while having a form which is bended at least one or more time in order that one side is exposed at the upper portion of the text panel.

9. The vehicle instrument panel of claim 8, further comprising a diffusion panel and a reflector which diffuses and reflects a light respectively between the prism and the LCD.

10. The vehicle instrument panel of claim 8, further comprising a plurality of LEDs (Light Emit Diode) which deliver a light to the pointer and the LCD.

11. The vehicle instrument panel of claim 8, further comprising a step motor which rotates the pointer.

12. The vehicle instrument panel of claim 8, further comprising a flexible cable which delivers a power and a control signal to the LCD.

13. A vehicle instrument panel comprising:
a text panel indicating a graduation and a character;
a pointer having a multi-bending shape, while an end portion moves over the surface of the text panel; and
a display unit.

14. The vehicle instrument panel of claim 13, wherein the display unit is the same height as the text panel and indicates vehicle information.

15. A vehicle comprising the vehicle instrument panel of claim 1.
